(19) United States
(12) Patent Application Publication
(10) Pub. No.: US 2020/0349172 A1
(43) Pub. Date: Nov. 5, 2020

(54) MANAGING CODE AND DATA IN MULTI-CLUSTER ENVIRONMENTS

(71) Applicant: Microsoft Technology Licensing, LLC, Redmond, WA (US)

(72) Inventors: Ionut Constandache, Sunnyvale, CA (US); Scott M. Meyer, Berkeley, CA (US); Bogdan G. Arsintescu, San Jose, CA (US); Matus Faro, Sunnyvale, CA (US); Yongling Song, Dublin, CA (US); Jiajun Yao, San Jose, CA (US)

(21) Appl. No.: 16/399,628

(22) Filed: Apr. 30, 2019

(51) Int. Cl. G06F 16/27; G06F 11/14; G06F 16/901; G06F 8/65

(52) U.S. Cl. CPC G06F 16/275; G06F 11/1451; G06F 11/1469; G06F 2201/80; G06F 8/65; G06F 2201/84; G06F 16/9024

(57) ABSTRACT

The disclosed embodiments provide a system for managing code and data in a multi-cluster environment. During operation, storage nodes in a first cluster execute instances of a scheduler that initiates actions including creating a database image, copying the database image, and loading the database image. Next, the scheduler issues, to a synchronization service, a first action to be performed by a second cluster based on a deployment schedule for data in a distributed database. Upon receiving a confirmation that the first action has been completed, the first cluster performs a second action received from the synchronization service to manage deployment of data in the distributed database on the first cluster. Upon completing the second action at a storage node in the first cluster, the storage node issues a completion of the second action to the synchronization service.

### BACKGROUND

### Field

The disclosed embodiments relate to distributed system management. More specifically, the disclosed embodiments relate to techniques for managing code and data in multi-cluster environments.

### Related Art

Distributed system performance is important to the operation and success of many organizations. For example, a company may provide websites, web applications, mobile applications, databases, content, and/or other services or resources through hundreds or thousands of servers in multiple data centers around the globe. An anomaly or failure in a server or data center may disrupt access to a service or a resource, potentially resulting in lost business for the company and/or a reduction in consumer confidence that results in a loss of future business. For example, high latency in loading web pages from the company's website may negatively impact user experience with the website and deter some users from returning to the website.

At the same time, distributed systems experience scheduled and/or unscheduled down time that can disrupt the availability, performance, and/or throughput of the distributed systems. For example, a bug in a distributed database is commonly remedied by manually deploying a patch on every node of the distributed database. After the patch is applied, the database is manually restarted on each node, and the database image is rebuilt on the node. While a node restarts and/or rebuilds the database image, the node is unable to process queries of the database. The node also experiences additional downtime whenever an error or failure occurs and/or if the software for the database is incompatible with the data stored in the database. To bring the node back up, an administrator has to manually remedy the error, failure, and/or incompatibility on the node. Moreover, the likelihood of a problem occurring in the distributed database increases with the number of nodes. Consequently, the overhead and/or complexity associated with managing a distributed system increases with the number of nodes and/or the amount of code and/or data in the distributed system.

### BRIEF DESCRIPTION OF THE FIGURES

FIG. 1 shows a schematic of a system in accordance with the disclosed embodiments.

FIG. 2 shows a graph in a graph database in accordance with the disclosed embodiments.

FIG. 3 shows a system for managing code and data in a multi-cluster environment in accordance with the disclosed embodiments.

FIG. 4 shows a flowchart illustrating a process of operating a storage node in a multi-cluster environment in accordance with the disclosed embodiments.

FIG. 5 shows a flowchart illustrating a process of executing a broker in a multi-cluster environment in accordance with the disclosed embodiments.

FIG. 6 shows a flowchart illustrating a process of executing a synchronization service in a multi-cluster environment in accordance with the disclosed embodiments.

FIG. 7 shows a computer system in accordance with the disclosed embodiments.

In the figures, like reference numerals refer to the same figure elements.

### DETAILED DESCRIPTION

The following description is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present invention is not limited to the embodiments shown, but is to be accorded the widest scope consistent with the principles and features disclosed herein.

### Overview

The disclosed embodiments provide a method, apparatus, and system for managing distributed systems. In these embodiments, a distributed system includes multiple applications, services, processes, and/or other components executing on a set of machines. To perform tasks within the distributed system, the components communicate, synchronize, and/or collaborate with one another over a network connection. As a result, an error, anomaly, and/or issue experienced by one component of a distributed system can be caused by and/or affect other nodes in the distributed system.

More specifically, the disclosed embodiments provide a method, apparatus, and system for managing code and data in multi-cluster environments. In these embodiments, a multi-cluster environment includes multiple computer clusters on which code and data are deployed. For example, the code includes a distributed database executing on nodes of the multi-cluster environment, and the data includes records in the distributed database. Thus, the code is executed to perform create, read, update, delete, and/or other operations related to the functionality of the distributed database.

To improve reliability, availability, throughput, and/or performance of the multi-cluster environment, a scheduler executes on nodes in each cluster of the multi-cluster environment. The scheduler issues actions to a centralized synchronization service according to a deployment schedule for code and/or data in the multi-cluster environment.

Each action identifies one or more clusters on which the action is performed. For example, the action includes, but is not limited to, creating a database image on a cluster, loading a database image from memory and/or disk on a cluster, validating a database image on one cluster using a different cluster, copying a database image from one cluster to another, snapshotting a database image on one or more clusters, deleting a database image on one or more clusters, and/or other operations related to managing data in the multi-cluster environment. As a result, the deployment schedule for the actions allows operations such as periodic database image updates, code deployments, and/or code or data rollbacks to be automated. The deployment schedule can also be overridden to perform rollbacks and/or fix issues or errors in the multi-cluster environment.

Moreover, identifying specific clusters on which each action is performed allows individual clusters to be used for different purposes. For example, inclusion of a cluster that is one version behind in code and/or data in the deployment schedule allows the cluster to act as a safety or backup cluster. In another example, a cluster that builds a new database image before copying the database image to other clusters operates as a “staging” cluster for the multi-cluster environment.

After one or more actions are issued by instances of the scheduler to the synchronization service, the synchronization service stores a single copy of each action and/or maintains a queue of distinct actions to perform. In turn, nodes in the clusters query the synchronization service for the “next” action to perform in the queue, and the cluster(s) to which the action is directed execute the action. After the action is completed, nodes in each cluster signal readiness to continue to the next action, and the next action is performed after all nodes are ready. If a node experiences an error or failure while performing a given action, the node queries the synchronization service for the action after restarting and resumes the action without requiring intervention by an administrator.

By executing multiple scheduler instances on nodes of a multi-cluster environment and issuing actions that are ordered and maintained by a synchronization service, the disclosed embodiments allow code and/or data deployments to be performed and/or automated in the multi-cluster environment independently of errors, failures, and/or outages in individual nodes and/or clusters. Sequentially executing the actions by the clusters and confirming the completion of each action before proceeding to the next action additionally ensures correct execution of deployment workflows in the multi-cluster environment, as well as recovery from the errors, failures, and/or outages. Moreover, decoupling the deployment of code from deployment of data in the multi-cluster environment reduces downtime, allows updating of the code and data on different schedules, and/or allows issues with the code (or data) to be remedied without affecting the data (or code). Consequently, the disclosed embodiments provide technological improvements in applications, tools, computer systems, and/or environments for managing deployment workflows, updates, errors, and/or failures in multi-cluster environments, distributed databases, and/or other types of distributed systems.

### Managing Code and Data in Multi-Cluster Environments

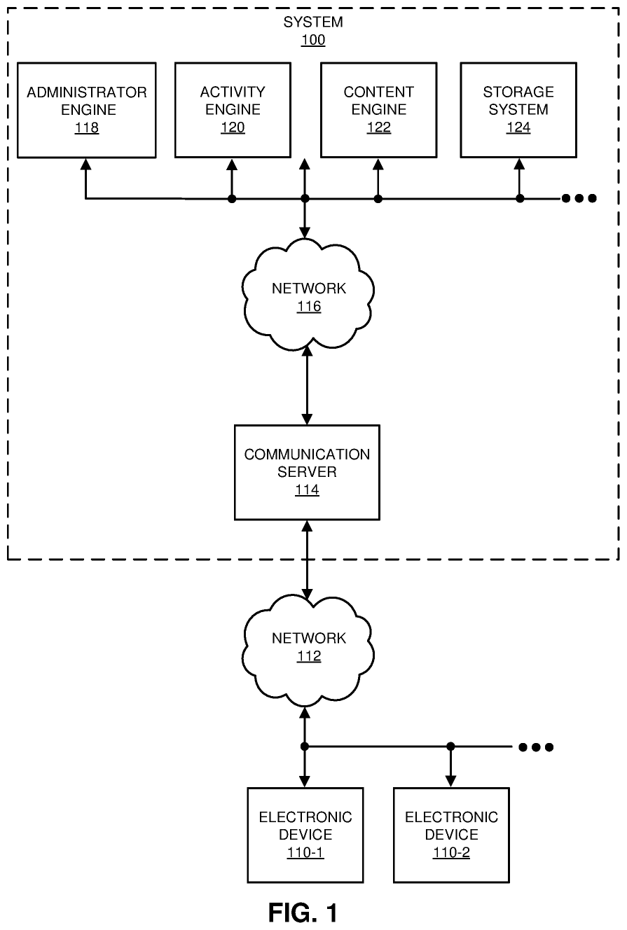

FIG. 1 shows a schematic of a system 100 in accordance with the disclosed embodiments. In this system, users of electronic devices 110 use a service that is provided, at least in part, using one or more software products or applications executing in system 100. As described further below, the applications are executed by engines in system 100.

Moreover, the service is provided, at least in part, using instances of a software application that is resident on and that executes on electronic devices 110. In some implementations, the users interact with a web page that is provided by communication server 114 via network 112, and which is rendered by web browsers on electronic devices 110. For example, at least a portion of the software application executing on electronic devices 110 includes an application tool that is embedded in the web page, and that executes in a virtual environment of the web browsers. Thus, the application tool is provided to the users via a client-server architecture.

The software application operated by the users includes a standalone application or a portion of another application that is resident on and that executes on electronic devices 110 (such as a software application that is provided by communication server 114 or that is installed on and that executes on electronic devices 110).

A wide variety of services can be provided using system 100. In the discussion that follows, a social network (and, more generally, a user community), such as an online professional network, which facilitates interactions among the users, is used as an illustrative example. Moreover, using one of electronic devices 110 (such as electronic device 110-1) as an illustrative example, a user of an electronic device uses the software application and one or more of the applications executed by engines in system 100 to interact with other users in the social network. For example, administrator engine 118 handles user accounts and user profiles, activity engine 120 tracks and aggregate user behaviors over time in the social network, content engine 122 receives user-provided content (audio, video, text, graphics, multimedia content, verbal, written, and/or recorded information) and provides documents (such as presentations, spreadsheets, word-processing documents, web pages, etc.) to users, and storage system 124 maintains data structures in a computer-readable memory that encompasses multiple devices, i.e., a large-scale storage system.

Note that each of the users of the social network have an associated user profile that includes personal and professional characteristics and experiences, which are sometimes collectively referred to as ‘attributes’ or ‘characteristics.’ For example, a user profile includes: demographic information (such as age and gender), geographic location, work industry for a current employer, an employment start date, an optional employment end date, a functional area (e.g., engineering, sales, consulting), seniority in an organization, employer size, education (such as schools attended and degrees earned), employment history (such as previous employers and the current employer), professional development, interest segments, groups that the user is affiliated with or that the user tracks or follows, a job title, additional professional attributes (such as skills), and/or inferred attributes (which may include or be based on user behaviors). Moreover, user behaviors include: log-in frequencies, search frequencies, search topics, browsing certain web pages, locations (such as IP addresses) associated with the users, advertising or recommendations presented to the users, user responses to the advertising or recommendations, likes or shares exchanged by the users, interest segments for the likes or shares, and/or a history of user activities when using the social network.

Furthermore, the interactions among the users help define a social graph in which nodes correspond to the users and edges between the nodes correspond to the users' interactions, interrelationships, and/or connections. However, as described further below, the nodes in the graph stored in the graph database can correspond to additional or different information than the members of the social network (such as users, companies, etc.). For example, the nodes may correspond to attributes, properties or characteristics of the users.

It can be difficult for the applications to store and retrieve data in existing databases in storage system 124 because the applications may not have access to the relational model associated with a particular relational database (which is sometimes referred to as an ‘object-relational impedance mismatch’). Moreover, if the applications treat a relational database or key-value store as a hierarchy of objects in memory with associated pointers, queries executed against the existing databases may not be performed in an optimal manner

For example, when an application requests data associated with a complicated relationship (which may involve two or more edges, and which is sometimes referred to as a ‘compound relationship’), a set of queries are performed and then the results may be linked or joined. To illustrate this problem, rendering a web page for a blog may involve a first query for the three-most-recent blog posts, a second query for any associated comments, and a third query for information regarding the authors of the comments. Because the set of queries may be suboptimal, obtaining the results can, therefore, be time-consuming. This degraded performance can degrade the user experience when using the applications and/or the social network.

In order to address these problems, storage system 124 includes a graph database that stores a graph (e.g., as part of an information-storage-and-retrieval system or engine). Note that the graph allows an arbitrarily accurate data model to be obtained for data that involves fast joining (such as for a complicated relationship with skew or large ‘fan-out’ in storage system 124), which approximates the speed of a pointer to a memory location (and thus may be well suited to the approach used by applications).

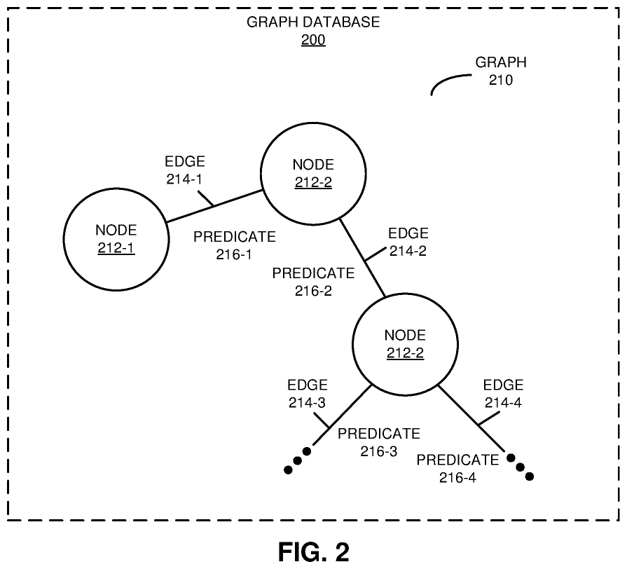

FIG. 2 presents a block diagram illustrating a graph 210 stored in a graph database 200 in system 100 (FIG. 1). Graph 210 includes nodes 212 and edges 214 between nodes 212 to represent and store the data with index-free adjacency, i.e., so that each node 212 in graph 210 includes a direct edge to its adjacent nodes without using an index lookup.

In one or more embodiments, graph database 200 includes an implementation of a relational model with constant-time navigation, i.e., independent of the size N, as opposed to varying as log(N). Moreover, all the relationships in graph database 200 are first class (i.e., equal). In contrast, in a relational database, rows in a table may be first class, but a relationship that involves joining tables may be second class. Furthermore, a schema change in graph database 200 (such as the equivalent to adding or deleting a column in a relational database) is performed with constant time (in a relational database, changing the schema can be problematic because it is often embedded in associated applications). Additionally, for graph database 200, the result of a query includes a subset of graph 210 that preserves the structure (i.e., nodes, edges) of the subset of graph 210.

The graph-storage technique includes embodiments of methods that allow the data associated with the applications and/or the social network to be efficiently stored and retrieved from graph database 200. Such methods are described in U.S. Pat. No. 9,535,963 (issued 3 Jan. 2017), entitled “Graph-Based Queries,” which is incorporated herein by reference.

Referring back to FIG. 1, the graph-storage techniques described herein allow system 100 to efficiently and quickly (e.g., optimally) store and retrieve data associated with the applications and the social network without requiring the applications to have knowledge of a relational model implemented in graph database 200. Consequently, the graph-storage techniques improve the availability and the performance or functioning of the applications, the social network and system 100, which reduce user frustration and improve the user experience. Therefore, the graph-storage techniques further increase engagement with or use of the social network and, in turn, the revenue of a provider of the social network.

Note that information in system 100 may be stored at one or more locations (i.e., locally and/or remotely). Moreover, because this data may be sensitive in nature, it may be encrypted. For example, stored data and/or data communicated via networks 112 and/or 116 may be encrypted.

In one or more embodiments, system 100 executes in a multi-cluster environment composed of multiple computer clusters. The computer clusters are located in one or more data centers, collocation centers, cloud computing systems, and/or other collections of processing, storage, network, and/or other resources.

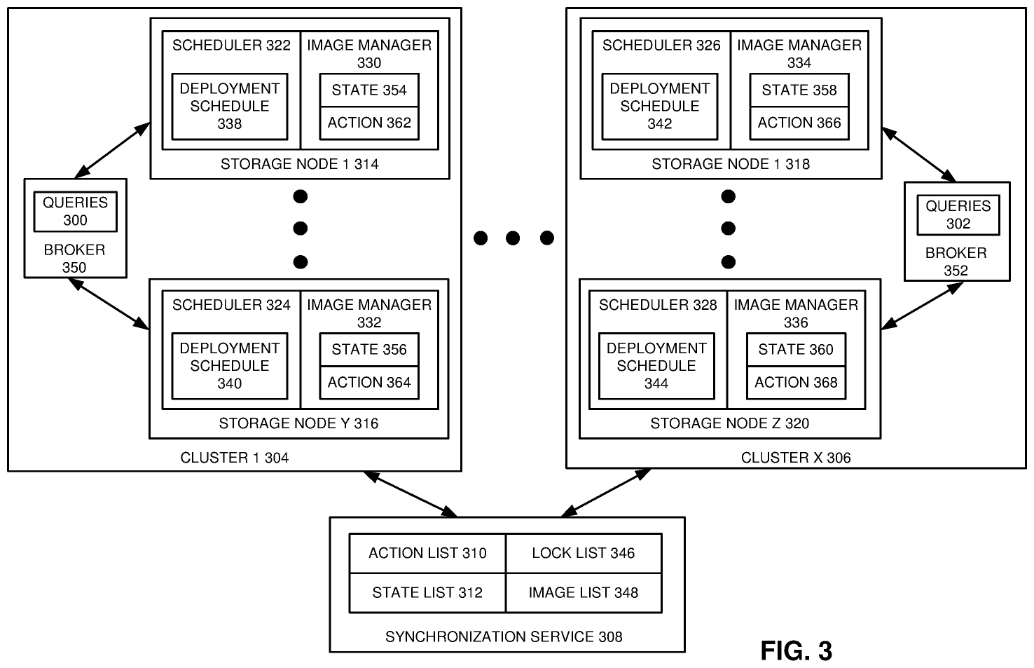

As shown in FIG. 3, a multi-cluster environment includes a number of clusters (e.g., cluster 1 304, cluster x 306) on which a distributed database (e.g., graph database 200 of FIG. 2) and/or other type of distributed application is deployed. In this environment, queries 300-302 of the database are provided to storage nodes in the clusters (e.g., storage node 1 314 to storage node y 316 in cluster 1 304, storage node 1 318 to storage node z 320 in cluster x 306) by brokers 350-352 associated with and/or inside each cluster.

For example, brokers 350-352 include Apache Kafka (Kafka™ is a registered trademark of the Apache Software Foundation) brokers that receive and/or publish queries 300-302 and/or other updates to the distributed database over Kafka event streams, topics, and/or partitions. Multiple instances of each broker may execute to scale with the volume of traffic to the distributed database and/or the number of storage nodes in each cluster. In response to queries 300-302 and/or updates received over the event streams, topics, and/or partitions, storage nodes in each cluster perform reads, writes, and/or other database operations to process the queries and/or update the database.

In the system of FIG. 3, the database is replicated across the clusters, with storage nodes in each cluster containing a complete copy of the database. For example, each cluster may contain 20 physical or virtual machines representing 20 storage nodes, with approximately 1/20 of the data in the graph database stored in each storage node. Storage nodes are added to existing clusters to reduce the memory footprint of each storage node, and new clusters are added to scale with the volume of queries 300-302 and/or to improve the reliability, availability, throughput, and/or performance of the database. Replication of the database across multiple clusters further allows queries 300-302 to be processed by a given cluster independently of the addition, removal, maintenance, downtime, and/or uptime of other clusters and/or storage nodes in the other clusters.

Data in the database is additionally divided into a set of logical partitions (shards). The partitions are distributed among the storage nodes in a one-to-one (i.e., one partition per storage node) or many-to-one (i.e., multiple partitions per storage node) fashion.

In one or more embodiments, the system of FIG. 3 includes functionality to automate and/or manage the deployment of code and data for the distributed database in the multi-cluster environment. More specifically, components of the system that are used to manage code and data in the multi-cluster environment include brokers 350-352, schedulers 322-328 on the storage nodes, image managers 330-336 on the storage nodes, and a synchronization service 308. Each of these components is described in further detail below.

As shown in FIG. 3, each storage node in each cluster includes functionality to execute a scheduler (e.g., schedulers 322-328) and an image manager (e.g., image managers 330-336). The scheduler issues actions to a centralized synchronization service 308 according to a deployment schedule (e.g., deployment schedules 338-344) for code and/or data in the multi-cluster environment.

Deployment schedules 338-344 include configurations that are used by the storage nodes to manage code and/or data in the corresponding clusters. For example, deployment schedules 338-344 include user-defined lists of scheduled actions (e.g., actions 362-368) to be performed by the storage nodes at the corresponding times. Administrators of the distributed database create the lists to automate various code and/or data management operations in the multi-cluster environment.

After an administrator and/or other entity creates or updates a deployment schedule, the deployment schedule is propagated to schedulers on the corresponding storage nodes and/or clusters without requiring restarting of the storage nodes. For example, the administrator uploads a configuration file containing the latest deployment schedule to a “live configuration” tool, and a listener on each storage node receives the latest deployment schedule from the tool and stores a local copy of the deployment schedule without interrupting the execution of the storage node.

Because the deployment schedule can be updated at each storage node without restarting the storage node, database administrators are able to use the deployment schedule for various purposes. For example, a database administrator loads a new deployment schedule onto storage nodes of one or more clusters to automate regular updates to code and/or data in the database, roll back the code and/or data to a previous version (e.g., when an error or issue occurs), apply a patch to the code, and/or carry out other regularly scheduled and/or remedial operations.

Each deployment schedule includes a set of fields that define actions to be performed by one or more nodes and/or clusters in the multi-cluster environment. These fields include, but are not limited to, a type of action, a source cluster, a target cluster, a start time, and/or a frequency.

As mentioned above, actions specified in deployment schedules 338-344 are used by the storage nodes to update and/or roll back database images and/or other data in the distributed database. Thus, the types of actions in the deployment schedule include, but are not limited to, creating a database image on a cluster, loading a database image from memory and/or disk on a cluster, validating a database image on one cluster using a different cluster, copying a database image from one cluster to another, snapshotting a database image on one or more clusters, deleting a database image on one or more clusters, and/or other operations related to managing data in the multi-cluster environment.

The deployment schedule also identifies one or more clusters to which a given action is applied. For example, the deployment schedule designates individual clusters for actions such as creating, loading, snapshotting (e.g., writing to disk), and/or deleting database images. In another example, the deployment schedule designates a source cluster and a target (or destination) cluster for actions such as copying a database image and/or validating a database image created on another cluster.

The deployment schedule also specifies a start time, frequency and/or other fields related to timing of the corresponding action. For example, the deployment schedule includes a timestamp specifying the starting date and time of a given action, as well as a number of hours and/or days between repetitions of the action.

In one or more embodiments, deployment schedules 338-344 stored at different nodes and/or clusters include copies of the same deployment schedule and/or different deployment schedules. For example, different deployment schedules are loaded onto nodes of different clusters to customize the clusters for operations related to development, integration, testing, staging, canary, backup, and/or production environments for the database. Conversely, the same deployment schedule is propagated to all clusters of the database, and different subsets of clusters are assigned different actions in the deployment schedule to configure the clusters for the same or different purposes related to the development, deployment, and/or release of the distributed database.

An example representation of a deployment schedule includes the following:

```
<property name = “imageManager.schedule” >
  <instanceDescriptors >
    <!-- Create image on staging -->
    <instance >
      <entry key = “action” value = “CREATE” />
      <entry key = “targetCluster” value = “cluster1” />
      <entry key = “start” value = “2019-01-01T09:00” />
      <entry key = “repeat” value = “7 DAYS” />
    </ instance >
    <!-- Validate data -->
    <instance >
      <entry key = “action” value = “VALIDATE” />
      <entry key = “sourceCluster” value = “cluster2” />
      <entry key = “targetCluster” value = “cluster1” />
      <entry key = “start” value = “2018-01-03T09:00” />
      <entry key = “repeat” value = “7 DAYS” />
    </ instance >
    <!-- Copy to canary -->
    <instance >
      <entry key = “action” value = “COPY” />
      <entry key = “sourceCluster” value = “cluster1” />
      <entry key = “destinationCluster” value = “cluster2” />
      <entry key = “start” value = “2018-01-03T10:00” />
      <entry key = “repeat” value = “7 DAYS” />
    </ instance >
    <!-- Copy to all but one production -->
    <instance >
      <entry key = “action” value = “COPY” />
      <entry key = “sourceCluster” value = “cluster2” />
      <entry key = “destinationCluster” value = “cluster3” />
      <entry key = “start” value = “2018-01-04T09:00” />
      <entry key = “repeat” value = “7 DAYS” />
  </ instance >
  <instance >
      <entry key = “action” value = “COPY” />
      <entry key = “sourceCluster” value = “cluster3” />
      <entry key = “destinationCluster” value = “cluster4” />
      <entry key = “start” value = “2018-01-05T09:00” />
      <entry key = “repeat” value = “7 DAYS” />
    </ instance >
    <!-- Copy to safety before deploying to last production -->
    <instance >
      <entry key = “action” value = “COPY” />
      <entry key = “sourceCluster” value = “cluster5” />
      <entry key = “destinationCluster” value = “cluster6” />
      <entry key = “skipInconnpatible” value = “true” />
      <entry key = “start” value = “2018-01-06T09:00” />
      <entry key = “repeat” value = “7 DAYS” />
    </ instance >
    <!-- Copy to last production -->
    <instance >
      <entry key = “action” value = “COPY” />
      <entry key = “sourceCluster” value = “cluster4” />
      <entry key = “destinationCluster” value = “cluster5” />
      <entry key = “start” value = “2018-01-07T09:00” />
      <entry key = “repeat” value = “7 DAYS” />
    </ instance >
  </ instanceDescriptors >
</ property >
```

The deployment schedule above includes a name of “imageManager.schedule” and a list of “instanceDescriptors” that define and/or describe actions to be performed according to the deployment schedule. Within the list, a first “instance” includes a value of “CREATE” for an “action” attribute, a value of “cluster1” for a “targetCluster” attribute, a value of “2019-01-01T09:00” for a “start” attribute, and a value of “7 DAYS” for a “repeat” attribute. A second “instance” includes a value of “VALIDATE” for the “action” attribute, a value of “cluster2” for a “sourceCluster” attribute, a value of “cluster1” for a “targetCluster” attribute, a value of “2019-01-03T09:00” for a “start” attribute, and a value of “7 DAYS” for a “repeat” attribute. A third “instance” includes a value of “COPY” for the “action” attribute, a value of “cluster1” for a “sourceCluster” attribute, a value of “cluster2” for a “destinationCluster” attribute, a value of “2019-03-01T10:00” for a “start” attribute, and a value of “7 DAYS” for a “repeat” attribute.

In the deployment schedule, a fourth “instance” includes a value of “COPY” for the “action” attribute, a value of “cluster2” for a “sourceCluster” attribute, a value of “cluster3” for a “destinationCluster” attribute, a value of “2019-01-04T09:00” for a “start” attribute, and a value of “7 DAYS” for a “repeat” attribute. A fifth “instance” includes a value of “COPY” for the “action” attribute, a value of “cluster3” for a “sourceCluster” attribute, a value of “cluster4” for a “destinationCluster” attribute, a value of “2019-01-05T09:00” for a “start” attribute, and a value of “7 DAYS” for a “repeat” attribute. A sixth “instance” includes a value of “COPY” for the “action” attribute, a value of “cluster5” for a “sourceCluster” attribute, a value of “cluster6” for a “destinationCluster” attribute, a value of “2019-01-06T09:00” for a “start” attribute, and a value of “7 DAYS” for a “repeat” attribute. A seventh “instance” includes a value of “COPY” for the “action” attribute, a value of “cluster4” for a “sourceCluster” attribute, a value of “cluster5” for a “destinationCluster” attribute, a value of “2019-01-07T09:00” for a “start” attribute, and a value of “7 DAYS” for a “repeat” attribute.

The deployment schedule above includes seven actions that are used to deploy a new database image in an environment with six clusters on a weekly basis. The first action creates the database image on a staging cluster named “cluster1.” The second action is performed two days after the first action (e.g., to give sufficient time to complete the first action) and uses a canary cluster named “cluster2” to validate the newly created image on “cluster1.” The third action is performed an hour after the second action and copies the new database image from “cluster1” to “cluster2.” The fourth action is performed 23 hours after the third action (e.g., after the deployment to the canary cluster has been tested and/or verified to be stable) and copies the new database image from “cluster2” to a production cluster named “cluster3.” The fifth action is performed a day after the fourth action and copies the new database image from “cluster3” to a production cluster named “cluster4.” The sixth action is performed a day after the fifth action and copies an older version of the database image from a production cluster named “cluster5” to a safety (i.e., backup) cluster named “cluster6.” The seventh action is performed a day after the sixth action and copies the new database image from “cluster4” to cluster5.”

Because the deployment schedule above identifies one or more clusters on which each action is performed, individual clusters can be configured for different purposes in the multi-cluster environment. For example, keeping “cluster6” one database image version behind in the deployment schedule allows the cluster to act as a safety or backup cluster for other clusters. In another example, “cluster1” acts as a staging cluster that builds a new database image before the database image is copied to other clusters.

Modifications to the deployment schedule above can be used to carry out other operations in the environment. For example, a variation of the deployment schedule utilizes a similar sequence of steps to deploy a new code build to the clusters. In another example, a rollback to an older database image is carried out by copying the older version of the database image from the backup cluster to other clusters and/or loading the older version from disk on the other clusters. In a third example, the deployment schedule includes deletion of a database image on a cluster after a certain number of days or weeks has passed since the database image was created (e.g., to comply with data protection and/or privacy regulations). In a fourth example, the deployment schedule includes snapshotting of a database image on a cluster on a periodic basis and/or prior to replacing the database image with a different version.

As mentioned above, schedulers 322-328 on the storage nodes use deployment schedules 338-344 to issue actions (e.g., actions 362-368) to be performed by the clusters. In some embodiments, multiple schedulers 322-328 are deployed in some or all storage nodes in the clusters to prevent the system from having a single point of failure in coordinating and/or carrying out code and/or data deployments.

In one or more embodiments, each scheduler runs in a loop that checks for scheduled actions, changes to the deployment schedule, changes in state (e.g., states 354-360) on the scheduler's cluster and/or other clusters, and/or other events. When a new deployment schedule is available, the scheduler retrieves the deployment schedule from the “live configuration” tool. When an action in the deployment schedule is meant to occur, the scheduler emits the action to synchronization service 308 and/or verifies that another scheduler has already emitted the action to synchronization service 308. When the age of a database image on the scheduler's cluster exceeds the threshold number of days or weeks, the scheduler issues a “delete” action to synchronization service 308 to trigger deletion of the database image on the cluster.

After a given action is issued by one or more schedulers to synchronization service 308, synchronization service 308 stores the action in an action list 310. For example, synchronization service 308 includes an Apache ZooKeeper service that maintains action list 310 in one or more in-memory data registers. In this exemplary embodiment, schedulers 322-328 read and write actions in action list 310 using a path for action list 310. Each action includes one or more attributes from the deployment schedule and/or the scheduler issuing the action, such as one or more clusters to which the action pertains, the type of action, additional information related to the action (e.g., a list of input files used to create a new database image), and/or an identifier or host name for the scheduler. When multiple schedulers issue the same action, synchronization service 308 stores a single copy of the action in action list 310. Synchronization service 308 additionally maintains an ordering of actions in action list 310 to enforce sequential consistency in the execution of the actions by the corresponding clusters.

Image managers 330-336 in the storage nodes execute separately from schedulers 322-328 and carry out actions 362-368 issued by schedulers 322-328. In one or more embodiments, each image manager executes in a loop that monitors action list 310 for new actions 362-368 to perform. If the current action in action list 310 does not pertain to the cluster in which the image manager resides, the image manager ignores the action. If the current action specifies deletion and/or snapshotting of a database image on the cluster in which the storage node resides, the image manager carries out the action.

In one or more embodiments, some or all actions in the multi-cluster environment are performed sequentially to ensure correct execution of updates and/or rollbacks of code and/or data in the database. To enforce sequential execution of such actions, image managers in clusters to which the actions pertain acquire locks before performing the actions. In an exemplary embodiment, all image managers in each cluster are required to acquire a lock before performing any action other than snapshotting or deleting a database image. To acquire the lock, an image manager issues the lock to a lock list 346 in synchronization service 308. The image manager is granted the lock if image managers in other clusters do not currently have a lock. If one or more image managers in another cluster have already acquired a lock, the image manager's lock is placed into a fair queue implemented by lock list 346 to allow the image manager to acquire the lock in an orderly manner

Those skilled in the art will appreciate that sequential execution of actions can be performed using other techniques. For example, schedulers 322-328 in the storage nodes are able to achieve sequential execution by executing the same schedule and issuing one action at a time. Thus, a given action is only issued by schedulers 322-328 after the previous action has been completed. In another example, schedulers 322-328 are able to issue multiple actions that are serialized and deduplicated in action list 310 by synchronization service 308, but image managers 330-336 do not execute a given action until the previous action has been completed.

After some or all image managers in a given cluster have acquired a lock, the corresponding storage nodes can proceed with the corresponding action. First, each storage node changes its state (e.g., states 354-360) within a state list 312 in synchronization service 308 from “ready” (e.g., ready to receive traffic) to “not ready” (e.g., not ready to receive traffic). For example, each storage node writes its state to a separate path in state list 312. In turn, one or more brokers (e.g., brokers 250-252) in each cluster monitor paths in state list 312 that represent storage nodes in the cluster. When a storage node signals that its state is “not ready” in the corresponding path within state list 312, brokers in the same cluster discontinue transmitting queries (e.g., queries 300-302) and/or other traffic to the storage node, thus allowing the storage node to perform the action without disruption.

Next, storage nodes in the cluster carry out the action for which the lock was obtained. For example, the storage nodes are able to create a new database image over a number of days, copy a database image from another cluster over a number of hours, and/or load a database image from disk over a number of minutes. After the action is completed by a storage node, the storage node changes its state in state list 312 from “not ready” to “ready” and publishes one or more attributes related to the completed action with the state change. One or more brokers in the same cluster detect the state change in state list 312, retrieve the attributes published with the state change, and optionally perform a safety check that compares the published attributes to expected values of the attributes. For example, a broker compares a database image name and/or schema version associated with a database image created, copied, and/or loaded by the storage node with database image names and/or schema versions associated with the same action performed by other storage nodes in the same cluster.

If the published attributes match the expected values, the brokers trigger the transmission of queries and/or other traffic to the storage node. If the published attributes do not match the expected values, the brokers do not enable queries and/or other traffic to the storage node and emit a warning or alert to allow an administrator to remedy the mismatch. After all storage nodes in the cluster have completed the action and passed the optional safety check, the lock for the action is released, and the next action in action list 310 is performed by storage nodes in the cluster to which the next action pertains.

In one or more embodiments, storage nodes in the multi-cluster environment include functionality to automatically recover from errors, failures, restarts, and/or other issues in a way that maintains sequential consistency in the execution of actions 362-368. First, when a storage node experiences an error or failure while performing an action in action list 310, the node queries synchronization service 308 for the action after restarting, reacquires a lock using lock list 346, and resumes the action until the action is complete. Because traffic to the storage node was discontinued by brokers in the same cluster prior to the start of the action, the storage node is able to safely recover from the error failure and resume the action without requiring additional intervention and/or coordination with other components of the system.

Moreover, a storage node that restarts during an action can resume the action from a checkpoint, thus reducing the amount of time required to complete the action after the restart. For example, the storage node resumes a copy action from a checkpoint representing a last successfully copied file, a database creation action from a checkpoint representing a last successful write to a database image, and/or a snapshotting action from a checkpoint representing a last successfully snapshotted block and/or other unit of data.

Second, when a storage node starts up (e.g., during addition of a new cluster to the environment and/or after a code deployment), the storage node retrieves a database image that is compatible with the code on the storage node according to a preferential ordering of actions. In one or more embodiments, actions in the ordering are sorted by ascending time required to perform each action.

For example, the preferential ordering includes loading the database image from memory, followed by loading the database image from persistent storage, followed by copying the database image from another cluster, followed by creating a new database image. Thus, the storage node uses a database image in memory and/or on disk if the database image is compatible with the code deployed on the storage node. If the storage node lacks a local copy of a compatible database image, the storage node obtains a list of available database images and locations of the database images from an image list 348 maintained by synchronization service 308 and tries to copy a compatible database image from another cluster. If the storage node is unable to copy a compatible database image from another cluster, the storage node creates an in-memory database image from a set of input files. If the storage node is unable to obtain or create a compatible database image via any of the methods described above, the storage node logs a warning to allow an administrator to address the lack of compatible database image for the storage node.

In other words, the ordering of actions allows the storage node to fetch a compatible database image in the least amount of time possible. After the database image is loaded on the storage node, the image manager on the storage node signals a “ready” state in state list 312, and brokers in the same cluster begin serving traffic to the storage node.

By executing multiple scheduler instances on nodes of a multi-cluster environment and issuing actions that are ordered and maintained by a synchronization service, the disclosed embodiments allow code and/or data deployments to be performed and/or automated in the multi-cluster environment independently of errors, failures, and/or outages in individual nodes and/or clusters. Sequentially executing the actions by the clusters and confirming the completion of each action before proceeding to the next action additionally ensures correct execution of deployment workflows in the multi-cluster environment, as well as recovery from the errors, failures, and/or outages. Moreover, decoupling the deployment of code from deployment of data in the multi-cluster environment reduces downtime, allows updating of the code and data on different schedules, and/or allows issues with the code (or data) to be remedied without affecting the data (or code). Consequently, the disclosed embodiments provide technological improvements in applications, tools, computer systems, and/or environments for managing deployment workflows, updates, errors, and/or failures in multi-cluster environments, distributed databases, and/or other types of distributed systems.

Those skilled in the art will appreciate that the system of FIG. 3 may be implemented in a variety of ways. As mentioned above, multiple instances of brokers 350-352 and/or synchronization service 308 may be used to manage traffic to storage nodes and/or coordinate actions among the storage nodes and/or clusters. Along the same lines, schedulers 322-328, image managers 330-336, brokers 350-352, and synchronization service 308 may be provided by a single physical machine, multiple computer systems, one or more virtual machines, a grid, a number of clusters, one or more databases, one or more filesystems, and/or a cloud computing system. Schedulers 322-328, image managers 330-336, brokers 350-352, and/or synchronization service 308 may additionally be implemented together and/or separately by one or more software components and/or layers.

Those skilled in the art will also appreciate that the system of FIG. 3 may be adapted to other types of functionality. For example, operations related to automatically updating and/or rolling back code and/or data in the distributed database may be used with other types of applications, data, and/or data stores.

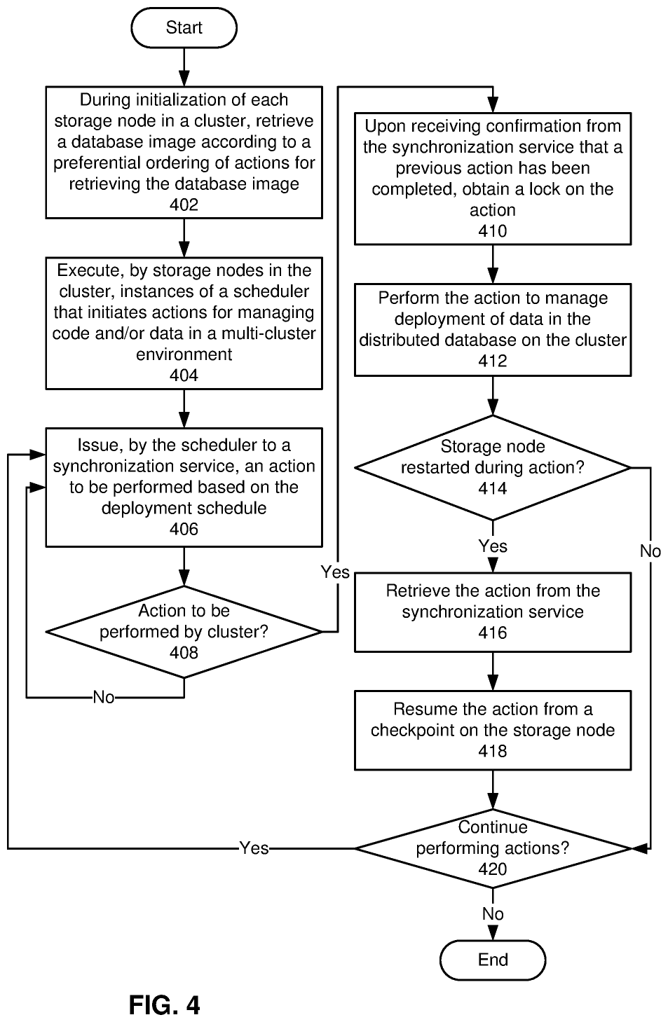

FIG. 4 shows a flowchart illustrating a process of operating storage nodes in a multi-cluster environment in accordance with the disclosed embodiments. In one or more embodiments, one or more of the steps may be omitted, repeated, and/or performed in a different order. Accordingly, the specific arrangement of steps shown in FIG. 4 should not be construed as limiting the scope of the embodiments.

The process begins with retrieving a database image according to a preferential ordering of actions for retrieving the database image during initialization of each storage node in a cluster (operation 402). The preferential ordering includes loading the database image from memory, followed by loading the database image from persistent storage, followed by copying the database image from another cluster, followed by creating a new database image. Thus, each storage node uses the preferential ordering to fetch a database image and configure the database image for local use in the shortest amount of time possible.

Next, the storage nodes in the cluster execute instances of a scheduler that initiates actions for managing code and/or data in the multi-cluster environment (operation 404). For example, the scheduler includes a deployment schedule with a list of scheduled actions. Each scheduled action includes a type of action, one or more clusters to which the action is applied, a start time, and/or a frequency. The type of action includes, but is not limited to, creating a database image, copying a database image, loading a database image, snapshotting a database image, and/or deleting a database image.

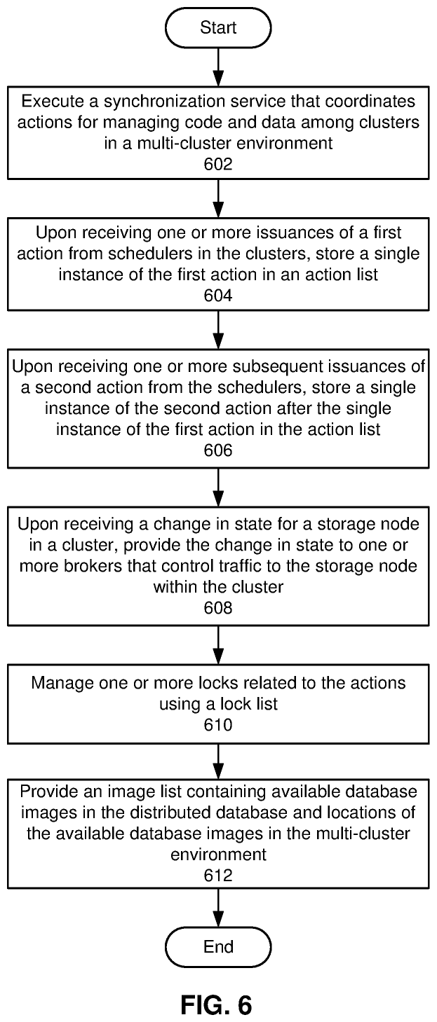

The scheduler then issues, to a synchronization service, an action to be performed based on the deployment schedule (operation 406). For example, the scheduler publishes the action to an action list maintained by the synchronization service. In turn, the synchronization service deduplicates actions and maintains a sequential ordering of actions issued by multiple instances of the scheduler, as described in further detail below with respect to FIG. 6.

The cluster may be identified as responsible for performing the action (operation 408). If the action is not to be performed by the cluster, the scheduler issues another action to be performed based on the deployment schedule (operation 406). If the issued action is to be performed by the cluster, storage nodes in the cluster obtain a lock on the action upon receiving confirmation from the synchronization service that a previous action has been completed (operation 408). For example, the storage nodes are able to obtain the lock after a lock on the previous action has been fully released by all nodes on a different cluster.

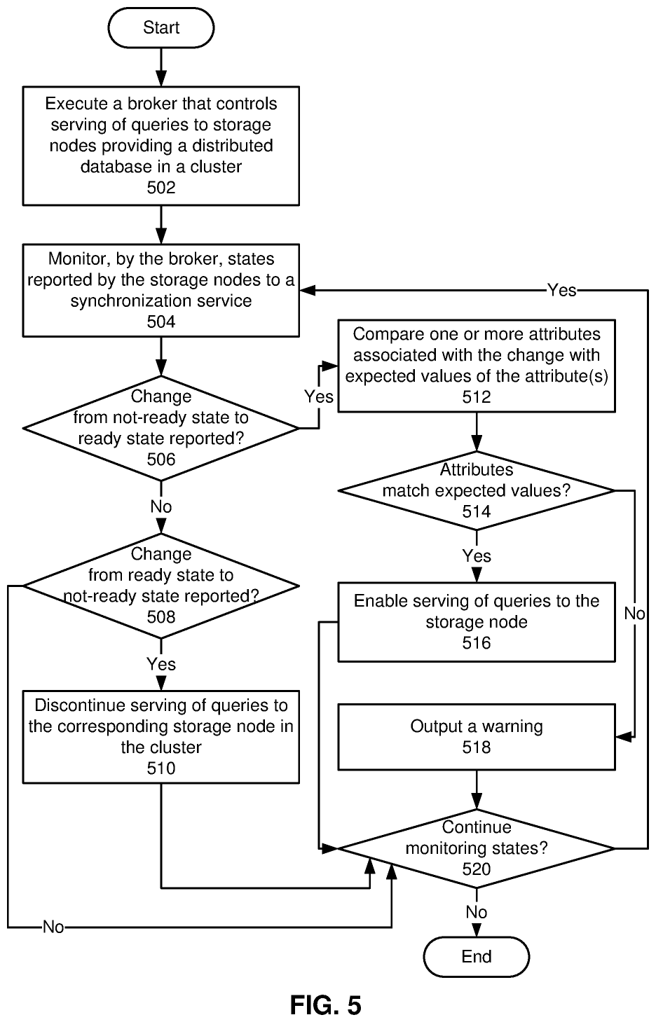

After the lock is acquired, the action is performed to manage deployment of data in the distributed database on the cluster (operation 412). For example, the storage nodes perform the action in parallel on different subsets (e.g., partitions or shards) of data in the distributed database. Prior to performing the actions, the storage nodes optionally signal a change in state from “ready” to “not ready” to the synchronization service. In response to the change in state, one or more brokers in the same cluster discontinue serving of queries and/or traffic to the storage nodes, as described in further detail below with respect to FIG. 5.

A storage node may be restarted during the action (operation 414). For example, the storage node may be restarted after experiencing an error or failure while the storage node is performing the action. After the restart, the storage node retrieves the action from the synchronization service (operation 416) and resumes the action from a checkpoint (operation 418). For example, the storage node resumes a copy action from a checkpoint representing a last successfully copied file, a database creation action from a checkpoint representing a last successful write to a database image, and a snapshotting action from a checkpoint representing a last successfully snapshotted block and/or other unit of data. If no storage nodes are restarted during the action, the storage nodes continue performing the action until the action is complete.

Actions may continue to be performed (operation 420) by storage nodes and/or clusters in the multi-cluster environment. For example, the storage nodes and/or clusters may use the deployment schedule to issue and/or perform actions (operations 406-418) while the multi-cluster environment is used to execute the distributed database. In turn, the issued and executed actions allow the storage nodes and/or clusters to automate deployments, roll backs, and/or other workflows related to managing code and/or data in the multi-cluster environment.

FIG. 5 shows a flowchart illustrating a process of executing a broker in a multi-cluster environment in accordance with the disclosed embodiments. In one or more embodiments, one or more of the steps may be omitted, repeated, and/or performed in a different order. Accordingly, the specific arrangement of steps shown in FIG. 5 should not be construed as limiting the scope of the embodiments.

First, a broker that controls serving of queries to storage nodes providing a distributed database in a cluster is executed (operation 502). For example, one or more instances of the broker execute on one or more physical and/or virtual machines in the cluster. Each instance controls the delivery of network traffic and/or queries to one or more storage nodes in the cluster via one or more event streams.

Next, states reported by the storage nodes to a synchronization service are monitored by the broker (operation 504). The states include a “ready” state, in which a storage node signals readiness to accept traffic and/or queries, as well as a “not ready” state, in which a storage node signals a lack of readiness in accepting traffic and/or queries.

States reported by the storage nodes may include a change from a not-ready state to a ready state (operation 506) and/or a change from a ready state to a not-ready state (operation 508). If a storage node reports a change from a ready state to a not-ready state, the broker discontinues serving of queries to the storage node (operation 510). In turn, the storage node is able to perform an action associated with changing and/or updating the database image on the storage node without handling the queries.

If a storage node reports a change from a not-ready state to a ready state, one or more attributes associated with the change are compared with expected values of the attribute (operation 512) to determine if the attributes match the expected values (operation 514). For example, the attributes include a database image name and/or schema version that are included in the record of the storage node's state change, as provided by the synchronization service. The attributes may then be compared to values of the attributes from other storage nodes in the same cluster and/or values of the attribute associated with a corresponding action published by schedulers to the synchronization service to determine if the database image on the storage node matches database images on other storage nodes in the same cluster.

If the attributes associated with a storage node's change from the not-ready state to the ready state match the expected values, serving of queries to the storage node is enabled (operation 516). If the attributes do not match the expected values, a warning is outputted (operation 518). Alternatively, the comparison of attributes may be omitted, and serving of the queries to the storage node may be enabled after the storage node signals the ready state to the synchronization service.

Monitoring of states may continue to be monitored (operation 520) by the broker. For example, the broker may monitor states of the storage nodes in the cluster and control traffic based on the states and associated attributes (operations 504-518) while the cluster is used to process queries of the distributed database.

FIG. 6 shows a flowchart illustrating a process of executing a synchronization service in a multi-cluster environment in accordance with the disclosed embodiments. In one or more embodiments, one or more of the steps may be omitted, repeated, and/or performed in a different order. Accordingly, the specific arrangement of steps shown in FIG. 6 should not be construed as limiting the scope of the embodiments.

First, the synchronization service executes to coordinate actions for managing code and data among clusters in a multi-cluster environment (operation 602). For example, the synchronization service includes an Apache ZooKeeper service that provides sequential consistency, atomicity, reliability, timeliness, and/or other guarantees to other components of the multi-cluster environment.

Upon receiving one or more issuances of a first action from schedulers in the clusters, the synchronization service stores a single instance of the first action in an action list (operation 604). The synchronization service thus deduplicates multiple issuances of the action from the schedulers into a single record in the action list.

Upon receiving one or more subsequent issuances of a second action from the schedulers, the synchronization service stores a single instance of the second action after the single instance of the first action in the action list (operation 606). For example, the synchronization service orders the first and second actions for subsequent retrieval and execution of the actions in a sequential fashion by storage nodes in the clusters.

The synchronization service also manages one or more locks related to the actions using a lock list (operation 610) and provides an image list containing available database images in the distributed database and locations of the available database images in the multi-cluster environment (operation 612). For example, the synchronization service stores locks so that a storage node is able to obtain a lock if storage nodes in another cluster have not already acquired a lock. If a storage node requests a lock but is unable to acquire one at the moment, the lock is placed in a fair queue implemented by the lock list to allow the storage node to acquire the lock after an existing lock is released by storage nodes in another cluster. In another example, the image list includes names of available database images and clusters in which the database images are located. A cluster can use the image list to locate a database image that is compatible with the database version in the cluster and copy the database image from another cluster.

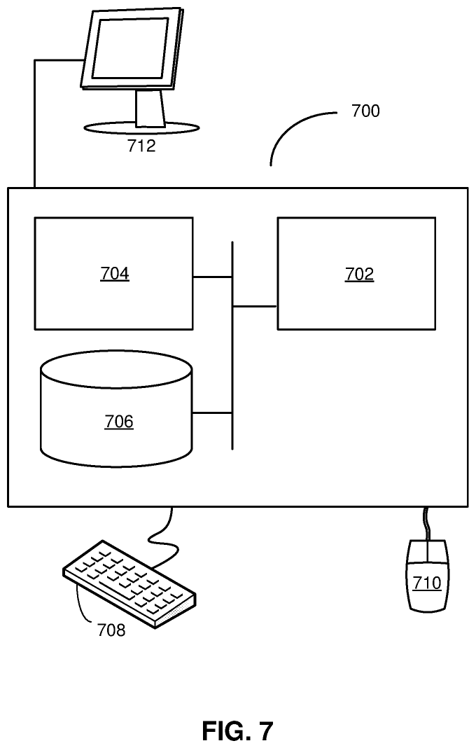

FIG. 7 shows a computer system in accordance with the disclosed embodiments. Computer system 700 includes a processor 702, memory 704, storage 706, and/or other components found in electronic computing devices. Processor 702 may support parallel processing and/or multi-threaded operation with other processors in computer system 700. Computer system 700 may also include input/output (I/O) devices such as a keyboard 708, a mouse 710, and a display 712.

Computer system 700 may include functionality to execute various components of the present embodiments. In particular, computer system 700 may include an operating system (not shown) that coordinates the use of hardware and software resources on computer system 700, as well as one or more applications that perform specialized tasks for the user. To perform tasks for the user, applications may obtain the use of hardware resources on computer system 700 from the operating system, as well as interact with the user through a hardware and/or software framework provided by the operating system.

In one or more embodiments, computer system 700 provides a system for managing code and data in a multi-cluster environment. The system includes storage nodes in a first cluster that execute a scheduler that initiates actions. The scheduler issues, to a synchronization service, a first action to be performed by a second cluster based on a deployment schedule for data in a distributed database. Upon receiving a confirmation from the synchronization service that the first action has been completed by the second cluster, the first cluster performs a second action received from the synchronization service to manage deployment of data in the distributed database on the first cluster. Upon completing the second action at a storage node in the first cluster, the storage node issues a completion of the second action to the synchronization service.

The system also includes a broker that controls serving of queries to storage nodes providing a distributed database in the cluster. The broker monitors states reported by the storage nodes to a synchronization service. When a first storage node in the cluster reports a change from a not-ready state to a ready state to the synchronization service, the broker compares one or more attributes associated with the change on the first storage node with expected values of the one or more attributes. When the attributes on all of the storage nodes match the expected values, the broker triggers serving of the queries to the storage nodes in the cluster.

The system also includes a synchronization service that coordinates actions for managing code and data among clusters in the multi-cluster environment. Upon receiving one or more issuances of a first action from schedulers of actions in the clusters, the synchronization service stores a single instance of the first action in an action list. Upon receiving one or more subsequent issuances of a second action from the schedulers, the synchronization service stores a single instance of the second action after the single instance of the first action in the action list. Upon receiving a change in state for a storage node in a cluster within the multi-cluster environment, the synchronization service provides the change in state to one or more brokers that control traffic to the storage node within the cluster.

In addition, one or more components of computer system 700 may be remotely located and connected to the other components over a network. Portions of the present embodiments (e.g., storage nodes, schedulers, image managers, brokers, synchronization service, clusters, distributed database, etc.) may also be located on different nodes of a distributed system that implements the embodiments. For example, the present embodiments may be implemented using a cloud computing system that manages the deployment and/or rollback of code and/or data in a set of remote clusters.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing code and/or data now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, methods and processes described herein can be included in hardware modules or apparatus. These modules or apparatus may include, but are not limited to, an application-specific integrated circuit (ASIC) chip, a field-programmable gate array (FPGA), a dedicated or shared processor (including a dedicated or shared processor core) that executes a particular software module or a piece of code at a particular time, and/or other programmable-logic devices now known or later developed. When the hardware modules or apparatus are activated, they perform the methods and processes included within them.

The foregoing descriptions of various embodiments have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention.

What is claimed is:

1. A method, comprising:
executing, by storage nodes in a first cluster, instances of a scheduler that initiates actions comprising creating a database image, copying the database image, and loading the database image;
issuing, by the instances of the scheduler to a synchronization service, a first action to be performed by a second cluster based on a deployment schedule for data in a distributed database;
upon receiving a confirmation from the synchronization service that the first action has been completed by all storage nodes in the second cluster, performing, by the storage nodes, a second action received from the synchronization service to manage deployment of data in the distributed database on the first cluster; and
upon completing the second action at a first storage node in the first cluster, issuing a completion of the second action to the synchronization service.

2. The method of claim 1, further comprising:
upon restarting the first storage node during the second action, retrieving the second action from the synchronization service; and
resuming the second action from a checkpoint on the first storage node.

3. The method of claim 2, wherein the checkpoint comprises at least one of:
a last successful copy;
a last successful write; and
a last successful snapshot.

4. The method of claim 1, further comprising:
during initialization of the first storage node in the first cluster, retrieving the database image on the first storage node according to an ordering of actions for retrieving the database image.

5. The method of claim 4, wherein the ordering of actions comprises:
loading the database image from memory;
loading the database image from persistent storage;
copying the database image from another cluster; and
creating a new database image.

6. The method of claim 4, wherein the initialization of the first storage node is associated with at least one of:
addition of the first cluster to a multi-cluster environment for executing the distributed database; and
deploying a change in code for the distributed database on the first cluster.

7. The method of claim 1, wherein the first action comprises creating the database image and the second action comprises copying the database image.

8. The method of claim 1, wherein the first action comprises copying the database image from the second cluster to a safety cluster and the second action comprises copying a new version of the database image from the first cluster to the second cluster.

9. The method of claim 1, wherein the first action comprises a rollback of the database image on the second cluster and the second action comprises a rollback of the database image on the first cluster.

10. The method of claim 1, wherein the deployment schedule comprises at least one of:
a type of action;
one or more clusters to which an action is applied;
a start time; and
a frequency.

11. The method of claim 1, wherein the distributed database comprises a graph database storing a graph, wherein the graph comprises a set of nodes, a set of edges between pairs of nodes in the set of nodes, and a set of predicates.

12. The method of claim 1, wherein the actions further comprise at least one of snapshotting the database image and deleting the database image.

13. A method, comprising:
executing, by one or more computer systems in a cluster, a broker that controls serving of queries to storage nodes providing a distributed database in the cluster;
monitoring, by the broker, states reported by the storage nodes to a synchronization service;
when a first storage node in the cluster reports a change from a not-ready state to a ready state to the synchronization service, comparing, by the broker, one or more attributes associated with the change on the first storage node with expected values of the one or more attributes; and
when the one or more attributes on all of the storage nodes match the expected values, triggering, by the broker, serving of the queries to the storage nodes in the cluster.

14. The method of claim 13, further comprising:
when a second storage node in the cluster reports a change from the ready state to the not-ready state to the synchronization service, discontinuing serving of the queries to the storage nodes in the cluster.

15. The method of claim 13, wherein comparing the one or more attributes of the distributed database on the first storage node with the expected values of the one or more attributes comprises:
obtaining the one or more attributes from a record of the ready state at the synchronization service.

16. The method of claim 15, wherein comparing the one or more attributes of the distributed database on the first storage node with the expected values of the one or more attributes further comprises:
obtaining the expected values from records associated with other storage nodes in the cluster.

17. The method of claim 13, wherein the one or more attributes comprise at least one of:
a database image name; and
a schema version.

18. The method of claim 13, wherein the broker controls serving of the queries over one or more event streams in a distributed streaming platform.

19. A non-transitory computer-readable storage medium storing instructions that when executed by a computer cause the computer to perform a method, the method comprising:
executing a synchronization service that coordinates actions for managing code and data among clusters in a multi-cluster environment, wherein the actions comprise creating a database image in a distributed database, copying the database image, and loading the database image;
upon receiving one or more issuances of a first action from schedulers of actions in the clusters, storing a single instance of the first action in an action list provided by the synchronization service;
upon receiving one or more subsequent issuances of a second action from the schedulers, storing a single instance of the second action after the single instance of the first action in the action list; and
upon receiving a change in state for a storage node in a cluster within the multi-cluster environment, providing the change in state to one or more brokers that control traffic to the storage node within the cluster.

20. The non-transitory computer-readable storage medium of claim 19, wherein the method further comprises:
managing one or more locks related to the actions using a lock list provided by the synchronization service; and
providing, on the synchronization service, an image list comprising available database images in the distributed database and locations of the available database images in the multi-cluster environment.
